(19) United States
(12) Patent Application Publication
(10) Pub. No.: US 2022/0100859 A1
(43) Pub. Date: Mar. 31, 2022

(54) REMOTE MANAGEMENT OF DEVICES

(71) Applicant: Arm Cloud Technology, Inc., San Jose, CA (US)

(72) Inventors: Marcus CHANG, Austin, TX (US); Brendan James MORAN, Histon (GB)

(21) Appl. No.: 17/038,438

(22) Filed: Sep. 30, 2020

(51) Int. Cl. G06F 21/57; G06F 21/64; G06F 21/53; G06F 8/658; G06F 8/61; G06N 20/00

(52) U.S. Cl. CPC G06F 21/572; G06F 21/64; G06N 20/00; G06F 8/658; G06F 8/63; G06F 21/53

(57) ABSTRACT

A method of remotely updating a firmware application stored in a memory of a device includes: obtaining state data indicative of a first partial firmware image stored in a first portion of the memory and corresponding to a base portion of the application; obtaining offset data for locating a second portion of the memory contiguously following the first portion of the memory; obtaining a second partial firmware image for appending to the first partial firmware image and corresponding to an updated auxiliary portion of the application; generating a differential update comprising at least part of the second partial firmware image; generating, using the state data and the generated second partial firmware image, firmware hash data corresponding to a composite firmware image comprising the second partial firmware image appended to the first partial firmware image; and transmitting the differential update and the generated firmware hash data to the device.

### BACKGROUND OF THE INVENTION

### Field of the Invention

The present disclosure relates to the updating of firmware on a network-enabled device. The disclosure has particular, but not exclusive, relevance to updating a machine learning model running in firmware on a network-enabled device.

### Description of the Related Technology

The Internet of things (IoT) describes a system of interconnected electronic devices, each of which has a unique identifier and a capability to transfer data over the Internet without requiring human intervention. Examples of such devices range from household appliances such as lighting fixtures, doorbells, audio speakers, televisions, washing machines and refrigerators, to energy or water meters, sensing devices and vehicles. Providing such devices with network connectivity allows for a wide range of functionalities to be implemented, for example performance monitoring, data gathering, real-time analytics and/or remote control of devices. In some cases, IoT devices make use of machine learning models to implement such functionalities. Data collected from multiple connected devices may, for example, be used to train the machine learning models running on those devices and others.

An IoT device as described above typically include one or more firmware applications for implementing the functionality of the device. A firmware image or a firmware binary is a portion of code written to a read-only memory (ROM) of a device, comprising low-level machine-readable instructions for implementing a given functionality (for example, controlling hardware or collecting data). Firmware is typically installed at the time of manufacturing of a device, but may be updated several times during the life-cycle of the device, for example to add security patches or to improve or modify the functionality of the device. In cases where an IoT device implements a machine learning model, the machine learning model may be included as part of the firmware image, and updating the firmware image may include updating the machine learning model, for example after the model has undergone training.

In many cases, a single enterprise or owner may be responsible for a large number of IoT devices, for example hundreds, thousands, or tens of thousands of similar devices. Management of a large number of devices, including for example managing data collected by the devices, managing firmware running on the devices, and managing device security, requires significant resources and infrastructure. Cloud-based device management platforms, such as the Arm® Pelion® IoT platform, have been developed to reduce the burden of managing IoT devices, whilst providing the device owner/operator with a customizable level of control over the devices. The provision of services by a cloud-based device management platform operated by a different entity to the device operator poses a number of technical challenges, for example relating to security and privacy, that must be addressed in order for a device operator to be able to use the platform safely.

### SUMMARY

According to a first aspect, there is provided a method of remotely updating a firmware application stored in a memory of a device. The method includes: obtaining state data indicative of a first partial firmware image stored in a first portion of the memory of the device and corresponding to a base portion of the application; obtaining offset data for locating a second portion of the memory of the device contiguously following the first portion of the memory of the device; obtaining a second partial firmware image for appending to the first partial firmware image and corresponding to an updated auxiliary portion of the application; generating, using the obtained offset data, a differential update comprising at least part of the second partial firmware image; generating, using the state data and the second partial firmware image, firmware hash data corresponding to a composite firmware image comprising the second partial firmware image appended to the first partial firmware image; and transmitting the differential update and the generated firmware hash data to the device.

According to a second aspect there is provided a computing system arranged to update a firmware application stored in a memory of a device. The computing system is arranged to: obtain state data indicative of a first partial firmware image stored in a first portion of the memory of the device, the first partial firmware image comprising a base portion of the application; obtain offset data for locating a second portion of the memory of the device contiguously following the first portion of the memory of the device; obtaining a second partial firmware image for appending to the first partial firmware image and corresponding to an updated auxiliary portion of the application; generate, using the obtained offset data, a differential update comprising at least part of the second partial firmware image; generate, using the state data and the second partial firmware image, firmware hash data corresponding to a composite firmware image comprising the second partial firmware image appended to the first partial firmware image; and transmit the differential update and the generated firmware hash data to the device.

According to a third aspect, there is provided method of remotely updating a firmware application stored in a memory of a device. The method includes: transmitting, to a device management system, state data indicative of a first partial firmware image stored in a first portion of the memory of the device, the first partial firmware image corresponding to a base portion of the application; receiving, at the device, a differential update from the device management system comprising at least part of a second partial firmware image, wherein the second partial firmware image is arranged to be appended to the first partial firmware image and corresponds to an updated auxiliary portion of the application; receiving, at the device, first firmware hash data from the device management system; generating, using the received differential update, a composite firmware image comprising the second partial firmware image appended to the first partial firmware image; processing the composite firmware image to generate second firmware hash data corresponding to the composite firmware image; and replacing the firmware image stored on the device with the composite firmware image in dependence on a comparison between the first firmware hash data and the second firmware hash data.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic block diagram representing an example of a system for updating a firmware application running on a set of IoT devices;

FIG. 2 is a schematic block diagram representing an example of an IoT device;

FIG. 3 is a flow diagram representing an example of a method of updating a firmware application running on an IoT device;

FIG. 4 is a flow diagram representing a first example of a method for obtaining state data corresponding to a partial firmware image;

FIG. 5 shows schematically the system of FIG. 1 performing a method as shown in FIG. 4;

FIG. 6 shows schematically the system of FIG. 1 performing a first example of a method of updating a firmware application running on a set of IoT device, following the method of FIG. 4;

FIG. 7 is a flow diagram representing a second example of a method for obtaining state data corresponding to a partial firmware image;

FIG. 8 shows schematically the system of FIG. 1 performing a method as shown in FIG. 7;

FIG. 9 shows schematically the system of FIG. 1 performing a second example of a method to update a firmware application running on a set of IoT devices; and

FIG. 10 shows schematically the system of FIG. 1 performing a third example of a method to update a firmware application running on a set of IoT devices.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further notes that certain examples are described schematically with certain features omitted and/or necessarily simplified for the ease of explanation and understanding of the concepts underlying the examples.

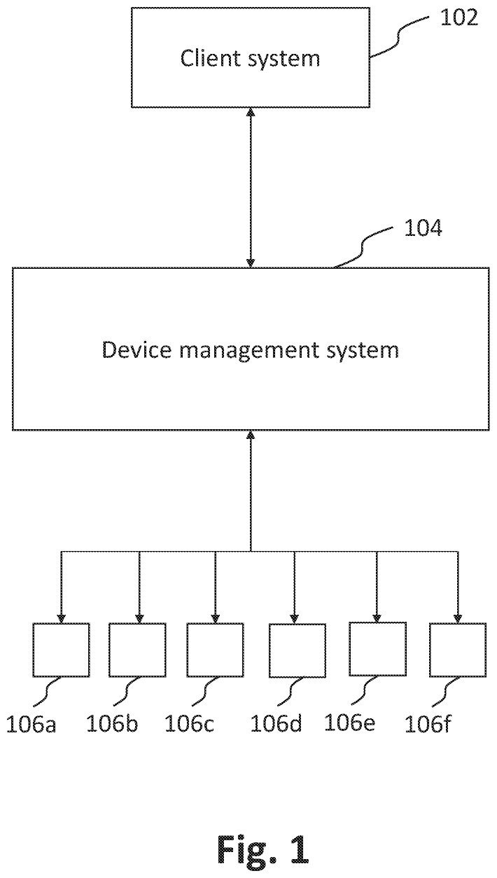

FIG. 1 shows a client system 102, a device management system 104, and multiple network-enabled devices, referred to collectively or individually as devices 106 (of which six devices 106a-f are shown). The device management system includes 104 processing circuitry and memory, and in this example is implemented using multiple networked servers, enabling cloud-based computing services to users such as the operator of the client system 102. The devices 106 are wireless devices and have the capability to communicate with the device management system 104 via a core network and a radio access network (RAN). In this example, the devices 106 communicate using wireless signals in accordance with the narrowband IoT (NB-IoT) standard, which has been developed from the Long Term Evolution (LTE) and Long Term Evolution-Advanced (LTE-A) standards to address specific requirements associated with IoT devices, including potentially large numbers of devices within a given area, low data rates, low power consumption, and low signal-to-noise ratio (for example where a device is deployed in a remote or enclosed area).

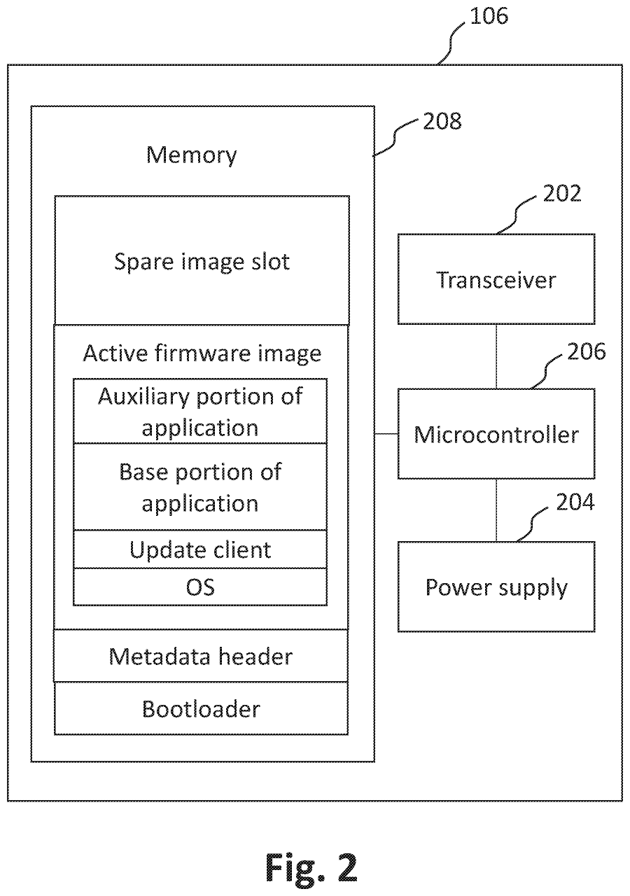

As shown in FIG. 2, each of the devices in this example 106a-f includes a radio transceiver 202, a power supply 204, processing circuitry in the form of a microcontroller 206, and non-volatile flash memory 208. The memory 208 holds code including a bootloader, a metadata header and an active firmware image. The active firmware image is stored in an active image slot in the memory 208. The memory 208 further includes a spare image slot for storing a replacement firmware image during a firmware update procedure, as will be explained in more detail hereafter. The active firmware image includes an operating system (OS), an update client, and a user application. In the present examples, the devices 106 use the Mbed® OS by Arm®, though other choices of OS may be used, for example a Linux-based OS such as the Raspberry Pi® OS or a real-time operating systems (RTOS) such as RTX by Arm® or FreeRTOS. In this example, the bootloader, metadata header and firmware image on a given device 106 are installed by the manufacturer of the device 106 before the device 106 is sold. In other examples, firmware may be installed at a later date and/or by a different entity to the manufacturer of the device.

Once the bootloader has been installed on a given device 106, the bootloader is never updated, and is responsible for ensuring that only a valid firmware image ever loads on the device 106. In the example of FIG. 2, memory addresses of the memory 208 run from bottom to top as depicted, such that the bootloader is placed at an allocated start address (for example, address 0x0). The bootloader is therefore executed by the microcontroller 206 each time the device 106 boots. The metadata header contains information pertaining to the active firmware image, including a hash of the active firmware image, and is used by the bootloader for validating the active firmware image before loading. A new metadata header is provided each time the active firmware image is updated on the device 106.

The update client on the device 106 is responsible for handling firmware updates. One way of updating firmware on one of the devices 106 is to prepare an entirely new firmware image and transmit the entirely new firmware image to the device, so that the update client on the device 106 can replace the active firmware with the new firmware image, subject to an authentication process. However, in many cases, only a portion of the firmware image is actually modified when the firmware is to be updated. In such cases, transmitting an entirely new firmware image is inefficient, resulting in unnecessary use of network resources and energy at the device, which may be limited for example if the device 106 does not have access to a mains power supply. An alternative method is to generate a differential update, also referred to as a delta update or a delta image. The differential update includes the modified portion or portions of the firmware image, along with information from which memory addresses of the potion or portions of the firmware image to be updated can be derived. Transmitting a firmware update as a differential update, rather than an entire replacement firmware image, can save network resources and energy consumed by an IoT device, for example when a firmware image only includes small code changes. In any case, a replacement firmware image or differential update may be sent to the devices 106 in an encrypted form using a public or private cryptographic key, and the devices 106 would be provided with a corresponding cryptographic key for decrypting the replacement firmware image or differential update.

In certain examples, a firmware application running on a device 106 may include a base portion, which is expected to be updated rarely or never during the life-cycle of the device, and an auxiliary portion, which is expected to be updated more frequently and independently of the base portion of the application. One example is an application which incorporates a machine learning model. In this example, the base portion of the application may include the majority of the code for operating the device 106, including for example generating data for input to the machine learning model and/or processing data generated by the machine learning model. The auxiliary portion of the application may include the machine learning model, which can be updated independently of the base portion of the application. For example, trainable parameters of the machine learning model may be adjusted once data has been collected from devices 106 connected to the device management system 104 and used to train the machine learning model. Alternatively, the machine learning model may be replaced with an entirely new machine learning model (for example, a neural network with a particular architecture, or any other suitable type of machine learning model). In this example, the machine learning model, or the trainable parameters of the machine learning model, may be considered an auxiliary portion of the application. Another example of an application with a base portion and an auxiliary portion is an application which includes configuration options or other parameters which can be modified to alter the operation of the application and/or the device 106. In this case, a configuration file or other updateable portion of the application including the configuration options may be considered an auxiliary portion of the application. A further example is a device 106 comprising a security-sensitive firmware portion such as a secure networking stack, which needs to be updated for security patches as and when said patches are available. In this example, the security-sensitive portion of the firmware is expected to be updated more frequently than other portions of the firmware application, and can be considered an auxiliary portion of the firmware application.

Generating and applying differential updates for firmware images provides a number of technical challenges, which the present disclosure sets out to address.

In a known method of generating a differential update for a device 106, a user supplies a firmware image currently active on the device 106, in addition to a replacement firmware image, to a device management system such as the device management system 104. The device management system compares the active firmware image with the replacement firmware image, determines which portion(s) of the application have been modified, and prepares a differential update including the modified portion(s) of the application and information indicating where the modified portion(s) need to be inserted. The device management system 104 also computes a hash of the replacement firmware image. The differential update and the hash are sent to the device 106 with one or more certificates signed by the firmware author. An update client on the device 106 then generates a copy of the replacement firmware image using the active firmware image and the differential update, and computes a hash of the generated copy. Before loading the replacement firmware image into an active image slot on the device 106, the bootloader on the device 106 compares the hash generated by the device 106 with the hash received from the device management system 104, to determine whether the replacement firmware image has been generated correctly and is authentic.

One problem with the method described above is that the device management system 104 needs to be able to access the active firmware image and the replacement firmware image in order to generate the differential update. There are several situations in which this may not be possible or desirable. One example is where a different entity, for example the operator of the device management system 104, is responsible for updating an auxiliary portion of an application such as a machine learning model. In this way, the device operator can hand responsibility for certain aspects of device management, for example machine learning and associated data management, to the device management system 104. As mentioned above, the device management system 104 is generally operated by a different entity than the device operator, and for security reasons, the device operator may be unwilling to provide the device management system 104 with a copy of the active firmware image. In other examples, the device operator may produce only a base portion of the firmware application, such that the auxiliary portion of the application (for example, the machine learning model) is the sole responsibility of the device management system 104.

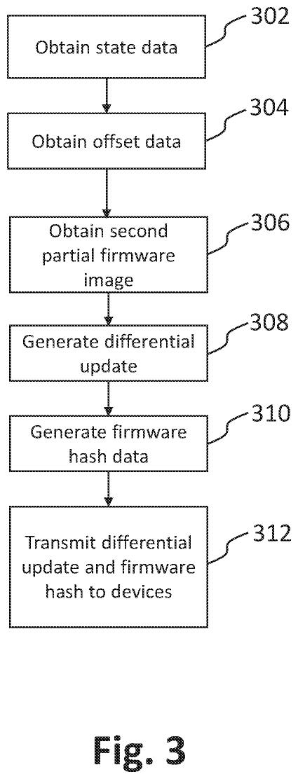

FIG. 3 shows an example of a method performed by the device management system 104 to remotely update a firmware application running on an IoT device 106 in accordance with the present disclosure. The device management system 104 obtains, at 302, state data indicative of a first partial firmware image stored in a first portion of the active image slot in the memory 208 of the device 106. The first partial firmware image in this example corresponds to the OS, the update client, and a base portion of the active firmware application running on the device 106. The application also includes an auxiliary portion, stored as a second partial firmware image in a second portion of the active image slot, where the second portion contiguously follows the first portion in terms of memory addresses. In this way, a composite firmware image is stored in the active image slot comprising the second partial firmware image containing the auxiliary portion of the application appended to the first partial firmware image containing the base portion of the application. The state data includes sufficient information to compute a hash of the composite firmware image, given the state data and the second partial firmware image. Due to the arrangement of the composite firmware image with the second partial firmware image following the first partial firmware image, the state data does not necessarily include the entirety of the first partial firmware image. Different forms of state data, and corresponding methods of obtaining the state data, will be discussed in more detail hereafter.

The device management system 104 obtains, at 304, offset data for locating the second portion of the active image slot. The offset data may include a memory offset, a specific memory address, or any other information from which a starting address of the second portion of the active image slot can be derived. In some examples, the offset data may be provided by the author of the firmware, for example via the client system 102. In other examples, the offset data may be derived by the device management system 104. Specific examples will be discussed hereinafter.

The device management system 104 obtains, at 306, a second partial firmware image arranged to be appended to the first partial firmware image running on the device 106. The second partial firmware image corresponds to an updated auxiliary portion of the application. The updated auxiliary portion of the application may include, for example, an updated machine learning model. The device management system 104 may generate the second partial firmware image, for example by processing data received from the devices 106 to train a machine learning model. Alternatively, the device management system 104 may receive the second partial firmware image from an external source. The second partial firmware image may be provided by a different entity to the device operator.

The device management system 104 generates, at 308, a differential update containing at least part of the second partial firmware image. As mentioned above, the differential update includes the necessary information for the device 106 to generate a replacement firmware image from the active firmware image. In this example, the differential update specifies one or more offset values from which memory addresses of the device 106 can be derived, where the derived memory addresses indicate which part or parts of the active firmware image on the device 106 are to be replaced. In some examples, the differential update may include the entire second partial firmware image (for example, where the auxiliary portion of the application is transmitted to the device 106 for the first time). In other examples, the device management system 104 may compute the differential update from an earlier version of the auxiliary portion of the application stored at the device management system 104, where the earlier version is already running on the device 106. In this case, the differential update may only include part of the second partial firmware image.

The device management system 104 generates, at 310, firmware hash data corresponding to a composite firmware image comprising the second partial firmware image appended to the first partial firmware image. The firmware hash data includes one or more hash values computed using one or more cryptographic hash algorithms, and is generated using the state data obtained at 302 and the differential update generated at 304. The firmware hash data is for later use by the devices 106 to authenticate the differential update.

The device management system 104 transmits, at 312, the generated differential update and firmware hash data to the device 106. In the present example, the update client on the device 106 is inactive until the device 106 receives a notification from the device management system 104 indicating that a firmware update is available. The notification may include a manifest for the firmware update or may include a request to download a manifest for the firmware update. The manifest is a data structure associated with the differential update and includes the firmware hash data. The update client uses the manifest to verify the authenticity and applicability of the differential update. The manifest includes a universal resource indictor (URI) indicating where the differential update can be found, in addition to one or more certificates signed by the device management system 104 and information for generating a metadata header for the resulting updated firmware image. Having parsed the manifest to obtain the URI of the firmware update, the update client on the device 106 downloads the differential update and uses the active firmware image and the differential update to generate an updated firmware image. The update client writes the updated firmware image to the spare image slot in the memory 208. The update client then reboots the device 106 and hands control back to the bootloader.

Before replacing the active firmware image with the updated firmware image, the bootloader checks the integrity of the updated firmware image by computing hash data for the active firmware image and comparing it to the firmware hash data received in the manifest. The bootloader may use further metadata received in the manifest to check that the updated firmware image is applicable to the device 106 and is newer than the active firmware image. Provided that the updated firmware image is applicable and newer than the active firmware image, the bootloader copies the updated firmware image to the active image slot, then forwards the control to the start of the application binary. The user application thereby gains control, and is able to receive further updates when they become available.

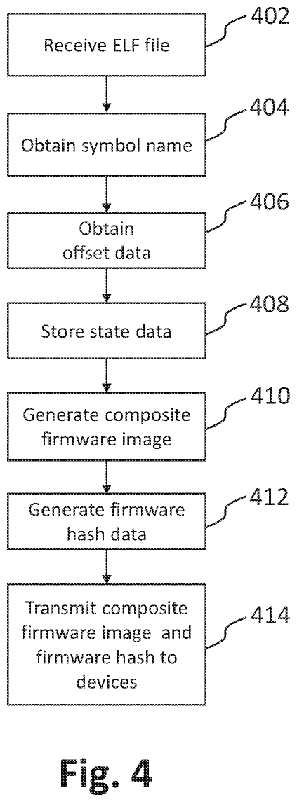

FIG. 4 shows a first method by which the device management system 104 may obtain state data for use in performing a firmware update as discussed with reference to FIG. 3 above. In this example, the device management system 104 receives, at 402, an executable linkable format (ELF) file corresponding to the base portion of the application. In the present example, the ELF file is compiled at the client system 102 and sent from the client system 102 to the device management system 104 at the request of the device operator. The ELF file does not necessarily include an auxiliary portion for the application. However, the ELF file includes a symbol name or identifier used to refer to a suitable auxiliary portion for the application, and the base portion of the application includes one or more calls or references to the auxiliary portion of the application using the symbol name or identifier.

The device management system 104 obtains, at 404, the symbol name used within the ELF file to refer to the auxiliary portion of the application. In some examples, the device operator may provide the symbol name along with the ELF file. In other examples, the device management system 104 may derive the symbol name from the ELF file, for example by detecting a symbol used in the base portion of the application and linking to a non-existent section of the ELF file. In other examples, the symbol name may be predetermined or chosen according to predetermined criteria, such that the device management system 104 can readily determine the symbol name.

The device management system 104 obtains, at 406, offset data for identifying the second portion of the memory 208 of the device 106. In the present example, the device management system 104 processes the received ELF file to generate the first partial firmware image, and computes a binary size of the first partial firmware image in bytes. The data management system 104 then determines the offset data in dependence on the determined binary size. In other examples, obtaining the offset data may include receiving the offset data along with the ELF file, in which case generating the first partial firmware image may not be necessary for determining the offset data.

The device management system 104 stores, at 408, state data which may include the ELF file, the first partial firmware image generated from the ELF file, or intermediate hash data corresponding to the first partial firmware image, along with the offset data obtained at 406. The state data includes sufficient information to compute a hash of a composite firmware image comprising the first partial firmware image and a given second partial firmware image, given the state data and the second partial firmware image. At this stage, the device management system 104 is in possession of the state data and, for any device 106 on which the first partial firmware image is already installed, may continue with the method of FIG. 3. In other examples, the first partial firmware image is not yet installed on a device 106, in which case the method may proceed to 410.

The device management system 104 generates, at 410, a composite firmware image comprising the first partial firmware image and a second partial firmware image appended to the first partial firmware image. The second partial firmware image corresponds to the auxiliary portion of the application, and is positioned relative to the first partial firmware image in accordance with the offset data determined at 406.

The device management system 104 generates, at 412, firmware hash data corresponding to the composite firmware image generated at 408. As discussed above, the firmware hash data is required by the device 106 to authenticate and validate the composite firmware image.

The device management system 104 transmits, at 414, the composite firmware image and the firmware hash to the device 106. In an example, the device management system 104 sends a notification to the device 106 including a manifest or a request to download a manifest for the composite firmware image. The update client on the device 106 downloads the composite firmware image from a URI indicated in the manifest and writes the composite firmware image to the spare image slot in the memory 208 of the device 106. The update client then reboots the device 106 and hands control to the bootloader, which checks the integrity of the composite firmware image before writing the composite firmware image to the active image slot. The bootloader then hands control to the user application. The device 106 is then able to receive further differential updates, as described above with reference to FIG. 3. It is noted that the firmware hash and the firmware image (or differential update) may be sent in a single transmission rather than separately using a manifest as described above.

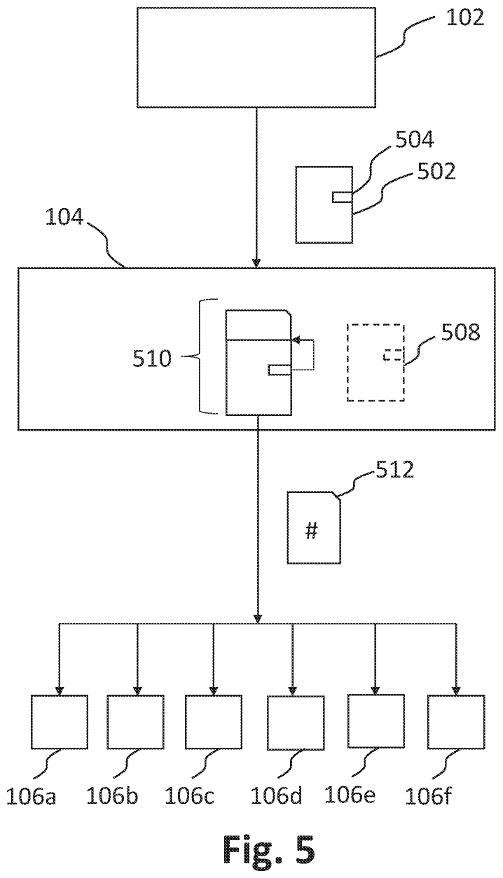

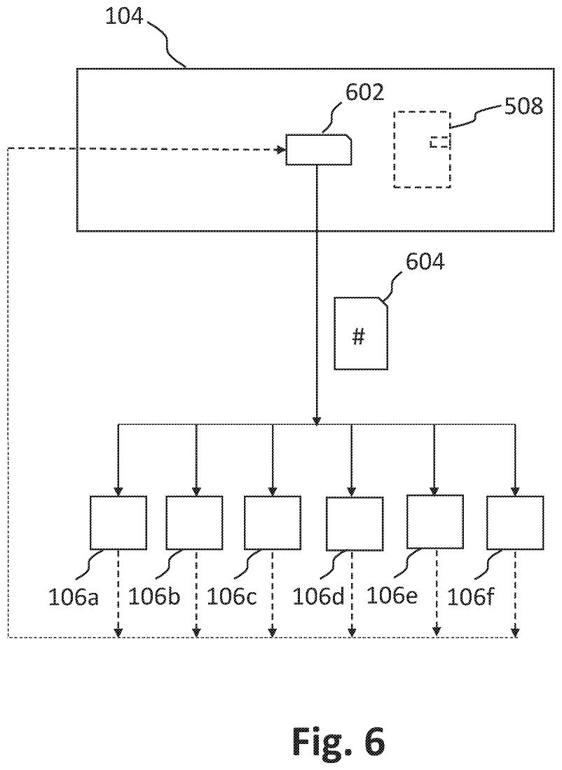

FIGS. 5 and 6 illustrate schematically the method of FIG. 4. As shown in FIG. 5, the device operator uploads an ELF file 502 to the device management system 104 via the client system 102. The ELF file 502 corresponds to a base portion of the application and includes a symbol reference 504 used to identify an auxiliary portion of the application. The device management system 104 stores state data 508 corresponding to the base portion of the application. The device management system 104 prepares a composite firmware image 510 comprising the auxiliary portion appended to the base portion, where the symbol reference 504 is used to link the base portion to the auxiliary portion, and generates firmware hash data 512 corresponding to the composite firmware image 510. The device management system 104 transmits the composite firmware image 510 to one or more devices 106, along with the firmware hash data 512.

In the example of FIGS. 5 and 6, the auxiliary portion of the application is a machine learning model. As illustrated by the long dashed arrow in FIG. 6, the device management system 104 collects data from the devices 106, and uses the collected data to update the machine learning model constituting the auxiliary portion of the application. When the device management system 104 has updated the auxiliary portion of the application (for example after a predetermined time, after a predetermined amount of data has been collected and processed or when a predetermined performance target has been reached), the device management system 104 prepare a differential update 602 corresponding to the updated auxiliary portion of the application, and generates updated firmware hash data 604 using the stored state data 508 and the updated auxiliary portion of the application. The device management system 104 then transmits the differential update 602 to the devices 106, along with the updated firmware hash data 604, without needing to re-transmit the base portion 502 of the application. By storing the state data 508, the device management system 104 is able to perform further updates without any further transmission of the base portion of the application.

The method illustrated in FIGS. 5 and 6 allows a device operator to completely hand over responsibility for an auxiliary portion of an application, such as a machine learning model, to the device management system 104. As mentioned above, the device management system 104 is typically operated by a different entity to the device operator. The device operator may be unwilling to allow the device management system 104 to access the base portion of the firmware application running on the devices 106, for example because the device operator does not trust the operator of the device management system 104 and/or because the device operator does not trust the security of the device management system 104. In this situation, the method of FIGS. 5 and 6 is unsuitable, because the device operator is required to provide the device management system 104 with an ELF file corresponding to the base portion of the application.

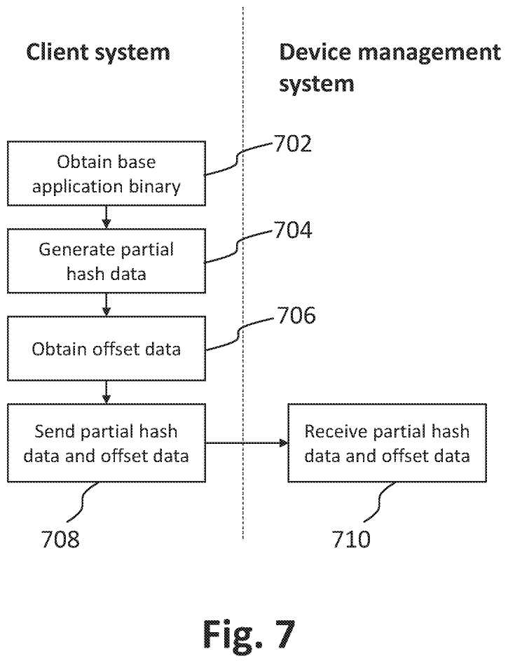

FIG. 7 shows a second method by which the device management system 104 may obtain state data for use in performing a firmware update as discussed with reference to FIG. 3. The client system 102 obtains, at 702, a first partial firmware image corresponding to the base portion of the application running on one or more of the devices 106. In some examples, the base portion of the application is coded and compiled by the device operator using the client system 102. In other examples, the base portion of the application may be coded and/or compiled by a different entity, for example by the manufacturer of the device 106, and subsequently sent to the client system 102.

The client system 102 generates, at 704, intermediate hash data corresponding to the first partial firmware image. The intermediate hash data may include, for example, an internal state of a hash engine comprising an intermediate result of a hash computation which sequentially processes bytes of the first partial firmware image. In other examples, the intermediate hash data may include multiple hash values or intermediate results, for example corresponding to different sections of the base portion of the application. The intermediate hash data contains sufficient information that, given the intermediate hash data and a second partial firmware image, complete firmware hash data can be computed corresponding to a composite firmware image comprising the second partial firmware image appended to the first partial firmware image. For example, an internal state of a hash engine may include an intermediate result of a hash computation which sequentially processes bytes of the first partial firmware image. The hash computation can subsequently be continued to process the second partial firmware image, resulting in a final firmware hash of the composite firmware image.

The client system 102 obtains, at 706, offset data for identifying the second portion of the active image slot on the device(s) 106 for which the firmware update is to be applied. The client system 102 may derive the offset data from the first partial firmware image, or alternatively a user of the client system 102 may enter the offset data. The client system 102 sends, at 708, the intermediate hash data and the offset data to the device management system 104, and the device management system 104 receives and stores the intermediate hash data and the offset data at 710. For a given auxiliary portion of the firmware application, the device management system 104 is thereby able to compute a firmware hash corresponding to the auxiliary portion of the application appended to the base portion of the application.

As described above, intermediate hash data may include an internal state of a hash engine. In an alternative example, intermediate hash data includes respective first hashes of one or more portions of the first partial firmware image, where each portion is stored in a respective sector of known size in the memory 208 of the device 106. In this example, the device management system 104 computes the final firmware hash corresponding to the composite firmware image by computing respective second hashes over one or more portions of the second partial firmware image and then computing a hash of the first and second hashes concatenated together. In order to authenticate the differential update, the device 106 computes hashes of the corresponding portions of the generated composite firmware image, computes a final hash of these hashes concatenated together, and compares this final hash with the firmware hash data received from the device management system 104. This example has the advantage that it is not necessary to expose an internal state of a hash engine, but does require a modification of the authentication process performed at the device 106, which may not be practical for example where a different entity to the device operator is responsible for providing the update client and/or bootloader on the device 106.

As an extension of the example described above, the device operator may further provide a signature over the one or more first hashes, using a cryptographic key (for example a private key) for which a corresponding key (for example a public key) is available to the device 106. The signature is provided to the device 106, along with an indication of the number N of portions forming the first partial firmware image (for example as part of the manifest associated with the differential update). By performing a signature verification algorithm using the corresponding key available to the device 106, the device 106 is able to verify that the differential update has not modified the base portion of the application stored on the device 106. This mitigates the risk of an attack where a malicious party attempts to modify the base portion of the application stored on the device 106, an example of which is described in more detail below.

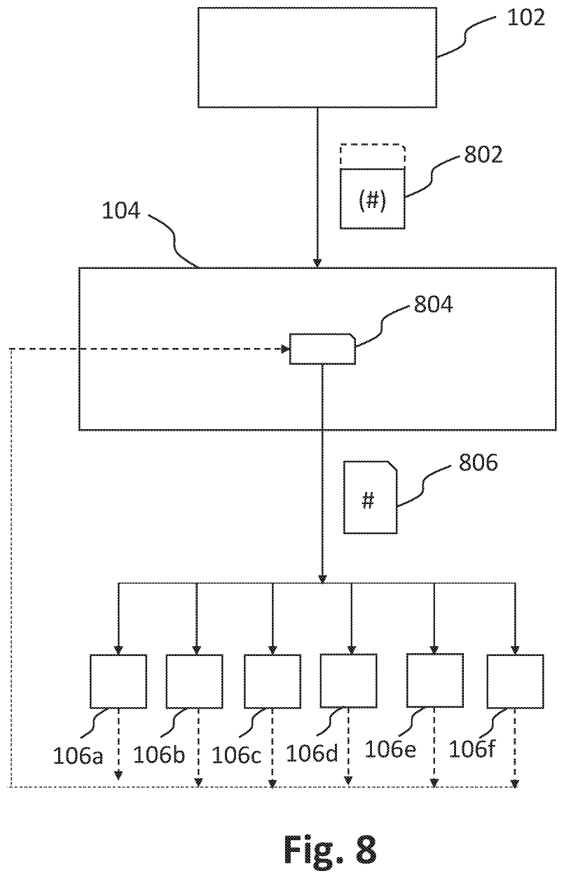

FIG. 8 illustrates the updating of firmware in accordance with the method of FIG. 7. The client system 102 sends intermediate hash data 802 to the device management system 104, corresponding to a base portion of the application running on one or more devices 106. The device management system 104 stores the intermediate hash data 802. The device management system 104 obtains an updated auxiliary portion of the application (in this example, by training a machine learning model using data received from the devices 106), and generates a differential update 804 corresponding to the updated auxiliary portion. The device management system 104 further generates firmware hash data 806 corresponding to a composite firmware image comprising the updated auxiliary portion appended to the base portion of the application. In the example that the partial has data includes an intermediate result of a hash computation, generating the firmware hash may involve completing the hash computation, starting from the intermediate state, by sequentially processing bytes of the updated auxiliary portion. The device management system 104 sends the differential update 804 to the devices 106.

Unlike the method described with reference to FIGS. 5 and 6, in which the first partial firmware image corresponding to the base portion of the application is generated by the device management system 104, in the method of FIGS. 7 and 8, the device management system 104 may not have information as to which version of firmware is running on any given device 106. In cases where different devices 106 may be running different versions of firmware, it may be desirable to only update the firmware on certain devices 106, for example those running older versions of the firmware, and/or those for which the firmware image is applicable. To ensure that the firmware update is only applied to the appropriate devices 106, the device management system 104 may receive reference hash data for one or more of the devices 106, corresponding to the active firmware image running on said one or more of the device 106. The reference hash data for each device 106 may include one or more hash values derived from the active firmware image running on said devices 106. The reference hash data may be received directly from the devices 106, or alternatively may be provided by the client system 102. The transmitting of the differential updates to a given devices 106 may then be dependent on the received reference hash data for that device. For example, the device management system 104 may transmit the differential update to each device 106 for which given reference hash data is received (e.g. corresponding to a firmware version which has not yet been updated and to which the differential update is applicable), or may transmit the differential update to all of a given set of devices 106, except those for which given reference hash data is received (e.g. corresponding to an already-updated firmware image). In this way, the device management system can ensure that the firmware update is applied to all of the intended devices, without wasting resources by sending firmware updates which are redundant or not applicable. By using reference hash data, the device management system 104 is unable to determine additional information about the firmware application running on the device 106, so the security of the system is maintained.

The method of FIGS. 7 and 8 has the advantage that the device operator is not required to provide the device management system 104 with the base portion of the application. The device operator is therefore able to make use of the device management system 104 for updating the auxiliary portion of the application, even if the device operator does not trust the entity operating the device management system 104 and/or the security of the device management system 104. However, in certain settings, particularly where the content of the base portion of the application contains highly sensitive or confidential code, even sending intermediate hash data may not be desirable. In particular, although it is very challenging to determine specific information about a given input to a hash engine (in this case, the base portion of the application) from an internal state of the hash engine, the intermediate hash data generally does not guarantee the same level of security a final hash value generated using a given hash algorithm. Therefore, users may be unwilling to provide intermediate hash data to the device management system 104. Furthermore, the method of FIGS. 7 and 8 requires the device operator to access software for generating intermediate hash data, which may not be desirable, particularly if such software is provided by an untrusted third party (such as the operator of the device management system 104).

Although the method of FIGS. 7 and 8 does not involve exposing the base portion of the application to the device management system 104, it may still be possible for the device management system 104 to modify the base portion of the application running on a device 106 by transmitting a differential update specifying that all or part of the base portion is replaced. Therefore, if a malicious party is able to access and tamper with the device management system 104, the malicious party may be able to use the device management system 104 to replace or modify a firmware image stored on the device 106. For example, a malicious party may use the device management system 104 to replace the auxiliary portion of the application on the device 106 with a malicious program which transmits the firmware image from the device 106 to the malicious party. The malicious party would then have access to the necessary information to perform a differential update, using the device management system 104, which replaces not only the auxiliary portion of the application, but also the base portion of the application running on the device 106.

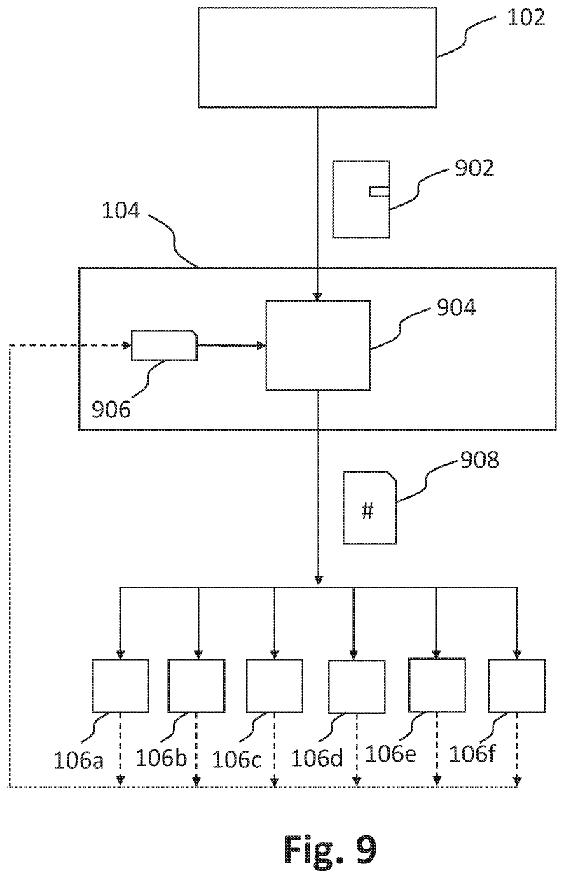

The issues described above are mitigated by the alternative example in which intermediate hash data is provided as individual hashes over multiple portions of the first partial firmware image. However, this method requires a modification of the authentication process performed at the device 106, which may not be possible or desirable. FIG. 9 illustrates an alterative method for updating firmware on the devices 106 without exposing the base portion of the application running on the devices 106. In this example, the client system 102 obtains state data 902 indicative of a first partial firmware image corresponding to the base portion of the application running on the devices 106. The state data 902 includes sufficient information to compute firmware hash data for a composite firmware image comprising a second partial firmware image appended to a first partial firmware image, given the state data and the second partial firmware image. The state data 902 may include, for example, the first partial firmware image itself, intermediate hash data corresponding to the first partial firmware image, or an ELF file corresponding to the base portion of the application running on the devices 106 as described above with reference to FIG. 4.

In this example, the client system 102 sends the state data 902 to a trusted execution environment 904, which in this example is implemented as part of the device management system 104, but in other examples may be implemented as part of a different system, for example via a cloud-based service. The trusted execution environment 904 comprises hardware which is isolated from other portions of the device management system 904, and uses a remote attestation protocol, which allows the client system 102 to ensure that the hardware and software running in the trusted execution environment 904 is identical to known hardware and software, which may for example have been audited by the device operator or by an entity trusted by the device operator. Trusted execution environments typically provide additional guarantees regarding leaking of data. The device operator can therefore be sure that any code executed by the trusted execution environment is exactly as expected, and that no data is leaked from the trusted execution environment to any other device or system, including the device management system 104. Various implementations of trusted execution environments are known, for example Arm® TrustZone and Intel® Software Guard Extensions (SGX). In this example, the trusted execution environment 904 stores one or more signing keys for signing differential updates to be transmitted to the devices 106, and the devices 106 have access to one or more corresponding keys for authenticating signatures generated by the trusted execution environment 904. The signing keys may be provided by the device operator or alternatively may be generated by the trusted execution environment 904, where in the latter case the trusted execution environment 904 presents the device operator with a certificate, which the device operator subsequently signs using its own keys to delegate authority for signing differential updates to the trusted execution environment 904. In this case, the signing keys generated by the trusted execution environment 904 are delegates of the keys possessed by the device owner 106.

The device management system 104 sends a second partial firmware image 906 to the trusted execution environment 904, corresponding to an updated auxiliary portion of the application. The trusted execution environment 904 processes the second partial firmware image 906 and the state data 902 to generate a differential update comprising at least part of the second partial firmware image, along with firmware hash data 908 indicative of a composite firmware image comprising the second partial firmware image appended to the first partial firmware image. The trusted execution environment 904 may also be arranged to perform certain checks specified by the device operator, for example to ensure that the auxiliary portion of the application starts at the correct address, that no bytes of the base application have been changed, and/or that the size of the auxiliary portion of the application lies between predetermined limits.

The trusted execution environment 904 signs the generated differential update and firmware hash data 908 using one of the stored signing keys. In this example, the code executed by the trusted execution environment 904 for generating the differential update and firmware hash data 908 has been audited by a party trusted by the device operator, and therefore using the remote attestation protocol, the device operator is able to verify that the trusted execution environment 904 is running the expected code will not leak any data (for example, information pertaining to the base portion of the application). In particular, the device operator is able to verify that the signing keys have not been leaked by the trusted execution environment 904, and therefore that the differential update was generated by the trusted execution environment 904, running the audited code. In this way, the trusted execution environment 904 is able to generate and sign the differential update 910 and corresponding firmware hash data 908 for sending to the devices 106, without exposing the base portion of the application running on the devices 106 to the operator of the device management system 104 or any other party. This mitigates the risk of an attack where a malicious party gains access to the device management system 104, for example with the intent to modify the base portion of the application running on the devices 106, because any modification to the code for generating of the differential update would be detectable. In another example, the generating of the differential update 906 may be performed outside of the trusted execution environment 904, whereas the generating of the firmware hash data 908 may be performed within the trusted execution environment 904.

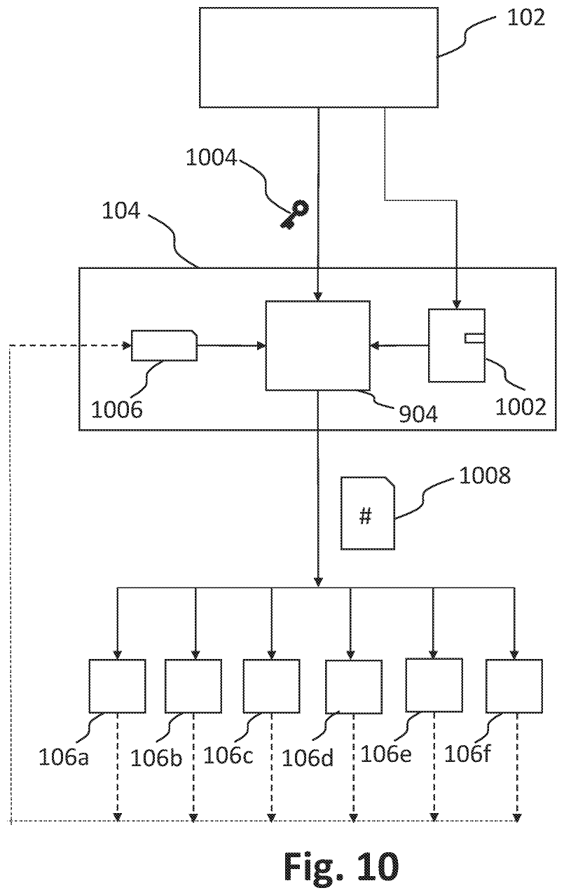

FIG. 10 shows an alternative implementation using the trusted execution environment 904. In this example, the client system 102 sends encrypted state data 1002 to the device management system 104. The device management system 104 does not possess a cryptographic key for decrypting the state data 1002, and therefore the device operator can safely provide the encrypted state data 1002 to the device management system 104, even if the device operator does not trust the entity operating the device management system 104. The client system 102 sends a cryptographic key 1004 for decrypting the state data 1002 to the trusted execution environment 904. The device management system 104 sends the encrypted state data 1002 and the second partial firmware image 1006 to the trusted execution environment 904, and the trusted execution environment 904 processes the state data 1002 and the second partial firmware image 1006 to generate a differential update and firmware hash data 1008 indicative of a composite firmware image comprising the second partial firmware image appended to the first partial firmware image.

The above embodiments are to be understood as illustrative examples of the invention. Further embodiments of the invention are envisaged. For example, different portions of the firmware image may be considered base and auxiliary portions of the firmware application. In some examples, the OS running on a device is considered to be the base portion of the firmware application, or part of the base portion of the application, allowing the present method to be used to update the user application or part of the user application without updating the OS.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of remotely updating a firmware application stored in a memory of a device, the method comprising:
obtaining state data indicative of a first partial firmware image stored in a first portion of the memory of the device, the first partial firmware image corresponding to a base portion of the application;
obtaining offset data for locating a second portion of the memory of the device contiguously following the first portion of the memory of the device;
obtaining a second partial firmware image for appending to the first partial firmware image and corresponding to an updated auxiliary portion of the application;
generating, using the obtained offset data, a differential update comprising at least part of the second partial firmware image;
generating, using the state data and the second partial firmware image, firmware hash data corresponding to a composite firmware image comprising the second partial firmware image appended to the first partial firmware image; and
transmitting the differential update and the generated firmware hash data to the device.

2. The method of claim 1, wherein:
obtaining the state data comprises receiving intermediate hash data corresponding to the first partial firmware image; and
generating the firmware hash data comprises processing the intermediate hash data and the second partial firmware image using a continued hash computation.

3. The method of claim 2, wherein the intermediate hash data comprises an intermediate state of a hash computation applied to the first partial firmware image.

4. The method of claim 2, further comprising receiving reference hash data corresponding to an active firmware image comprising the first partial firmware image and an active second partial firmware image appended to the first partial firmware image, the reference active second partial firmware image corresponding to a version of the auxiliary portion of the application currently running on the device,
wherein the transmitting of the differential update and firmware hash data is dependent on the reference hash data.

5. The method of claim 1, wherein obtaining the state data comprises:
receiving an executable linkable format, ELF, file comprising the base portion of the application;
obtaining a symbol reference used within the ELF file to identify the auxiliary portion of the application;
processing the ELF file to generate the first partial firmware image, wherein the processing comprises associating the symbol reference with the offset data for locating the second portion of the memory of the device; and
transmitting the first partial firmware image to the device.

6. The method of claim 5, wherein:
processing the ELF file further comprises generating an initial composite firmware image comprising the first partial firmware image and an initial second partial firmware image appended to the first partial firmware image, the initial second partial firmware image corresponding to an initial version of the auxiliary portion of the application; and
transmitting the first partial firmware image to the device comprises transmitting the initial composite firmware image to the device.

7. The method of claim 5, wherein obtaining the offset data for locating the second portion of the memory of the device comprises:
computing a binary size of the first partial firmware image; and
determining the offset data in dependence on the computed binary size of the first partial firmware image.

8. The method of claim 1, wherein the auxiliary portion of the application comprises a machine learning model; and
the base portion of the application includes at least one call to the machine learning model.

9. The method of claim 8, wherein the device is a first device, the method further comprising:
receiving analytics data from a plurality of devices including the first device; and
processing the received analytics data to generate the machine learning model,
wherein the updated auxiliary portion of the application comprises the generated machine learning model.

10. The method of claim 1, wherein:
obtaining the state data comprises receiving the state data at a trusted execution environment; and
the generating of the firmware hash data is performed within the trusted execution environment.

11. The method of claim 10, wherein the generating of the differential update is performed within the trusted execution environment.

12. The method of claim 11, further comprising the trusted execution environment signing the differential update and firmware hash data using a cryptographic key trusted by the device or by a delegate of a cryptographic key trusted by the device.

13. The method of claim 10, wherein the received state data is encrypted, the method further comprising receiving, at the trusted execution environment, a cryptographic key for decrypting the state data.

14. The method of claim 1, wherein obtaining the second partial firmware image comprises generating the second partial firmware image.

15. A computing system arranged to update a firmware application stored in a memory of a device, wherein the computing system is arranged to:
obtain state data indicative of a first partial firmware image stored in a first portion of the memory of the device, the first partial firmware image corresponding to a base portion of the application;
obtain offset data for locating a second portion of the memory of the device contiguously following the first portion of the memory of the device;
obtain a second partial firmware image for appending to the first partial firmware image and corresponding to an updated auxiliary portion of the application;
generate, using the obtained offset data, a differential update comprising at least part of the second partial firmware image;
generate, using the state data and the second partial firmware image, firmware hash data corresponding to a composite firmware image comprising the second partial firmware image appended to the first partial firmware image; and
transmit the differential update and the generated firmware hash data to the device.

16. The system of claim 15, wherein:
obtaining the state data comprises receiving intermediate hash data corresponding to the first partial firmware image; and
generating the firmware hash data comprises processing the intermediate hash data and the candidate second partial firmware image using a continued hash computation.

17. The system of claim 15, wherein obtaining the state data comprises:
receiving an executable linkable format, ELF, file comprising the base portion of the application;
obtaining a symbol reference used within the ELF file to identify the auxiliary portion of the application;
processing the ELF file to generate the first partial firmware image, wherein the processing comprises associating the symbol reference with the offset data for locating the second portion of the memory of the device; and
transmitting the first partial firmware image to the device.

18. The system of claim 15, arranged to generate the second partial firmware image.

19. The system of claim 15, further comprising a trusted execution environment, wherein:
obtaining the state data comprises receiving the state data at the trusted execution environment; and
the generating of the firmware hash data is performed within the trusted execution environment.

20. A method of remotely updating a firmware application stored in a memory of a device, the method comprising:
transmitting, to a device management system, state data indicative of a first partial firmware image stored in a first portion of the memory of the device, the first partial firmware image corresponding to a base portion of the application;
receiving, at the device, a differential update from the device management system comprising at least part of a second partial firmware image, wherein the second partial firmware image is arranged to be appended to the first partial firmware image and corresponds to an updated auxiliary portion of the application;
receiving, at the device, first firmware hash data from the device management system;
generating, using the received differential update, a composite firmware image comprising the second partial firmware image appended to the first partial firmware image;
processing the composite firmware image to generate second firmware hash data corresponding to the composite firmware image; and
replacing the firmware image stored on the device with the composite firmware image in dependence on a comparison between the first firmware hash data and the second firmware hash data.
